(19) United States
(12) Patent Application Publication
(10) Pub. No.: US 2003/0115260 A1
(43) Pub. Date: Jun. 19, 2003

(54) Systems and methods to facilitate location of a communication network subscriber via a home location privacy server

(76) Inventor: Stephen W. Edge, Escondido, CA (US)

Correspondence Address: Siemens Corporation, Attn: Elsa Keller, Legal Administrator, Intellectual Property Department, 186 Wood Avenue South, Iselin, NJ, 08830, US

(21) Appl. No.: 10/071,957

(22) Filed: Feb. 7, 2002

Related U.S. Application Data
(60) Provisional application No. 60/343,021, filed on Dec. 19, 2001.

(51) Int. Cl. G06F 15/16; G06F 7/00

(52) U.S. Cl. 709/203; 707/104.1

(57) ABSTRACT

Systems and methods are provided to facilitate location of a communication network subscriber via a home location privacy server. According to one embodiment, a home database server receives a network address request (e.g., a request associated with an attempt by a client device to locate a subscriber device). The home database server responds to the network address request by transmitting a privacy server network address. The home location privacy server may then receive a location request, evaluate privacy information associated with the subscriber device, and, depending on the results of the evaluation, provide the subscriber location directly or indirectly to the client device.

### CROSS REFERENCE TO RELATED APPLICATIONS

The present application claims the benefit of U.S. Provisional Patent Application Serial No. 60/343,021 entitled “Privacy Support for Wireless Location Services Using a Home Location Privacy Service”, listing inventor Stephen Edge, and filed on Dec. 19, 2001, the entire content of which is incorporated herein by reference.

### BACKGROUND OF THE INVENTION

The present invention relates to communication networks. In particular, the present invention relates to systems and methods to facilitate location of a communication network subscriber via a home location privacy server.

Certain services provided or enabled by a wireless communication network may be interested in the location of a subscriber or subscriber device (e.g., a subscriber's wireless telephone). Examples of such services include: emergency services (e.g., 911, or roadside assistance services), law enforcement services (e.g., associated with lost or stolen property), network maintenance services, commercial services (e.g., fleet management services), personal services (e.g., service that help find friends and family members), navigation services (e.g., that provide directions to local points of interest), and information services (e.g., local news, weather, advertising or traffic information). To help enable such services, a number of national and international standards are being (or have been) defined to facilitate the measurement and retrieval of the geographic location of a wireless communication device, such as a cellular telephone, a laptop computer, a Personal Digital Assistant (PDA), or a Personal Communications Services (PCS) handset. Some examples of such standards are those associated with the Telecommunications Industry Association (TIA), T1 digital lines, the 3^{rd} Party Partnership Project (3GPP), and 3GPP2.

FIG. 1 is an information flow diagram illustrating a known method of facilitating location of a subscriber device 150. At (A), a client device 110 transmits a location request. For example, a client device 110 associated with a roadside assistance service might transmit a location request including a subscriber's wireless telephone number and information about the client device 110.

The location request transmitted at (A) is received by a gateway location server 120 in a gateway communication network. Note that the client device 110 might not transmit the location request directly to the gateway location server 120. For example, the client device 110 might transmit the location request via an intermediate server, which in turn relays the request to the gateway location server 120.

The gateway location server 120 typically will not know the current location of the subscriber device 150. Instead, at (B) the gateway location server 120 transmits a network address request to a home database server 130 associated with the subscriber's home network. That is, the gateway location server 120 asks the home database server 130 to supply a network address associated with the communication network that is currently providing service to the subscriber device 150.

At (C), the home database server 130 responds by transmitting to the gateway location server 120 the network address associated with the communication network currently providing service to the subscriber device 150 (e.g., a visited network that is currently providing service to a roaming wireless telephone subscriber).

The gateway location server 120 uses the visited network address to transmit a location request to a visited network server 140 at (D). The location request may include, for example, the subscriber's wireless telephone number. The visited network server 140 may then communicate with the subscriber device 150 at (E) in order to determine the current location of the subscriber device 150.

When the current location of the subscriber device 150 is determined, the visited network server 140 transmits the location information to the gateway server 120 at (F), which in turn relays the information to the client device 110 at (G). The client device 110 can then proceed to provide a location-dependent service either to the subscriber (e.g., a roadside assistance service) or to another party (e.g., a friend or relative finder).

Often, a subscriber will want to (or be willing to) have his or her location disclosed in connection with such services. In some cases, however, a subscriber may prefer that his or her location not be disclosed (e.g., a subscriber may want to define when—or to whom—his or her location will be disclosed, for privacy reasons). By way of example, consider a subscriber who rents an automobile. The subscriber may provide his or her wireless telephone number to the rental company with the understanding that his or her location will be only be disclosed to a roadside assistance service when he or she has reported a problem with the automobile. Similarly, a sales representative may agree to be located by a first company between 9:00 AM and 1:00 PM and by a second company between 1:00 PM to 5:00 PM during the work week (and by neither company during the weekend).

A number of problems, however, may arise if such rules or restrictions are implemented using known methods of locating subscribers. Referring again to FIG. 1, the home database server 130 could store privacy information for each subscriber device 150 normally served by the home network. The visited network server 140, however, will not typically be aware of the privacy information associated with every visiting subscriber device 150. In this case, the visited network server 140 could mistakenly disclose location information to a gateway location server 120 when it should not be provided (or fail to disclose location information when it should be provided). Such a problem might arise, for example, if communication services are being provided to a subscriber device 150 in a different region or country than the home network (e.g., and the visited network does not have a relationship with the home network).

These problems might be partially solved by arranging for privacy related information in the home network (e.g., in the home database server) to be transferred to the visited network (e.g., to the visited network server) when the subscriber first establishes communication with the visited network. However, it might not be practical to have the visited network server 140 store accurate, complete, and up-to-date privacy information for every subscriber device 150 that is being (or could potentially be) served by the visited network, especially if privacy information is either (i) complex and precisely tailored to specific requirements of the subscriber and home network or (ii) frequently updated by subscribers. Similar problems may arise with attempts to have the gateway location server 120 store and/or evaluate privacy information. Moreover, both approaches require changes to visited network servers 140, home database servers 130, and/or gateway location servers 120 (e.g., changes to established communication protocols and their support by these entities).

In addition, while privacy information might be stored and satisfactorily evaluated in the home database server 130, major changes might then be required to currently standardized network signaling protocols and the currently defined capabilities of the gateway location server 120 and the home database server 130. Moreover, a home database server 130 is typically not designed or equipped to support a large volume of complex processing tasks such as those needed to verify privacy for all subscribers being located.

Another approach would be to simply ask the subscriber if his or her current location should be disclosed each time a location request is processed. This approach, however, may be inconvenient for the subscriber and not be effective when the subscriber is not using the subscriber device 150.

### SUMMARY OF THE INVENTION

To alleviate problems inherent in the prior art, the present invention introduces systems and methods to facilitate location of a communication network subscriber via a home location privacy server.

According to one embodiment, a network address request is received at a home database server, the network address request being associated with a subscriber device. A privacy server network address is then provided in response to the network address request.

According to another embodiment, a location request is received at a home location privacy server, the location request being associated with a subscriber device. Location information may then be determined in accordance with privacy information associated with the subscriber device. The location information is then provided in response to the location request.

According to still another embodiment, a network address request is received at a home database server, the network address request being associated with a client device and a subscriber device. A privacy server network address is then transmitted in response to the network address request. A location request is received at a home location privacy server, the location request being associated with the client device and the subscriber device. Location information may then be determined in accordance with privacy information associated with at least one of the client device and the subscriber device. The location information is then transmitted in response to the location request.

Along with various advantages and features of the invention that will become hereinafter apparent, these and other embodiments of the invention may be more clearly understood by reference to the following detailed description of the invention, the appended claims, and the attached drawings.

### BRIEF DESCRIPTION OF THE DRAWINGS

FIG. 1 is an information flow diagram illustrating a known method of facilitating subscriber location;

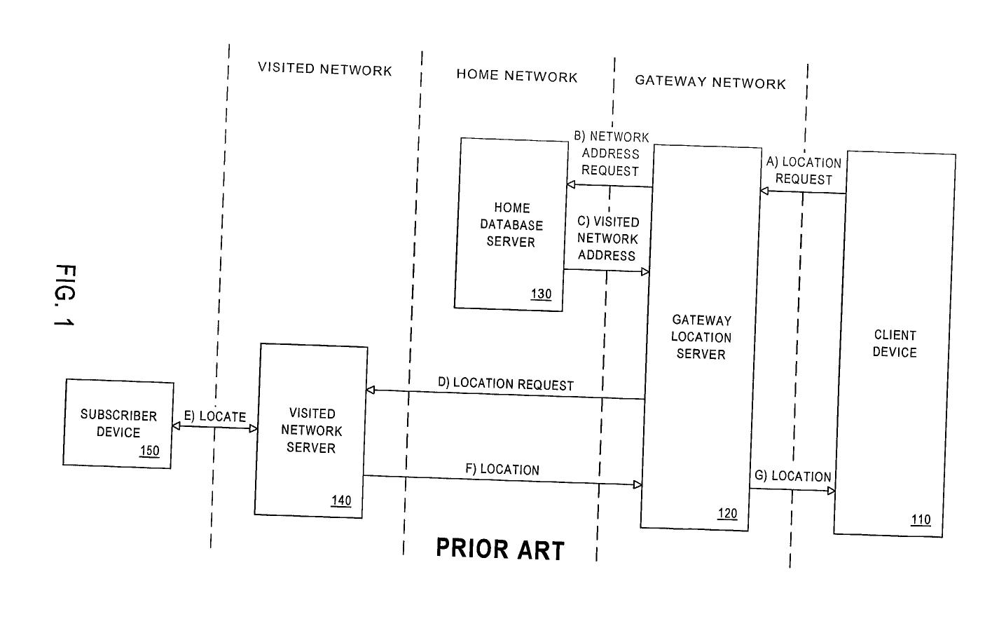

FIG. 2 is an information flow diagram according to some embodiments of the present invention;

FIG. 3 is a block diagram overview of a system according to some embodiments of the present invention;

FIG. 4 is a flow chart of a home database server method according to some embodiments of the present invention;

FIG. 5 is a flow chart of a home location privacy server method according to some embodiments of the present invention;

FIG. 6 is a block diagram of a home database server according to an embodiment of the present invention;

FIG. 7 is a tabular representation of a portion of a subscriber network database according to an embodiment of the present invention;

FIG. 8 is a block diagram of a home location privacy server according to an embodiment of the present invention;

FIG. 9 is a tabular representation of a portion of a subscriber privacy database according to an embodiment of the present invention; and

FIG. 10 is a flow chart of a home network method according to some embodiments of the present invention.

### DETAILED DESCRIPTION OF SPECIFIC EMBODIMENTS

Some embodiments of the present invention are directed to systems and methods to facilitate location of a communication network “subscriber” via a home location privacy server. As used herein, the term “subscriber” may refer to any user of a communication network, such as a wireless telephone network.

Information Flow Diagram

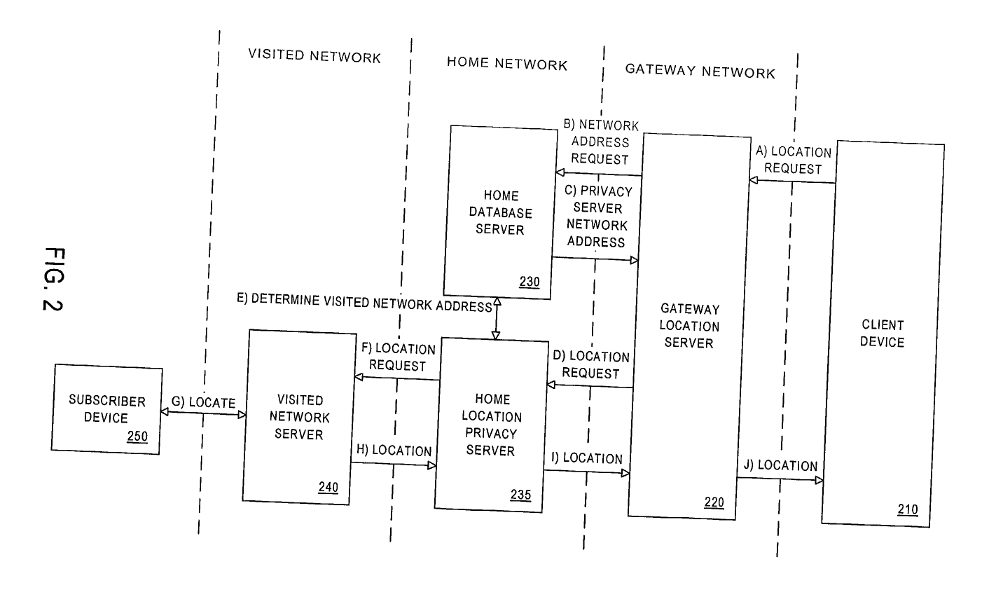

FIG. 2 is an information flow diagram according to some embodiments of the present invention. At (A), a client device 210 transmits a location request. For example, a client device 210 associated with a roadside assistance service might transmit a location request that includes a subscriber's wireless telephone number.

The location request transmitted at (A) is received by a gateway location server 220. Note that the client device 210 might not transmit the location request directly to the gateway location server 220. For example, the client device 210 might transmit the location request to an intermediate server, which in turn relays the request to the gateway location server 220.

At (B), the gateway location server 220 transmits a network address request or query to a home database server 230 associated with the subscriber's home network. The network address request may include, for example, the subscriber's wireless telephone number. The gateway location server 220 could determine the appropriate home database server based on the subscriber's wireless telephone number, as those versed in the art will be aware.

At (C), the home database server 230 responds by transmitting to the gateway location server 220 a privacy server network address (i.e., and not the actual network address associated with the communication network that is currently providing service to the subscriber). The privacy server network address may comprise, for example, a number assigned in accordance with the International Telecommunications Union (ITU) E.164 telephone and Integrated Services Digital Network (ISDN) numbering plan (e.g., including a country code, a national destination code, and a subscriber number that uniquely indicate a public network termination point).

At (D), the gateway location server 220 uses the privacy network address to transmit a location request to a home location privacy server 235 associated with the subscriber's home network. Note that the gateway location server 220 may not even be aware that the location request is not being transmitted to a network that is currently providing service to the subscriber device 250.

In response to the location request from the gateway location server 220, the home location privacy server 235 exchanges information with the home database server 230 at (E) to determine an address associated with the network currently providing service to the subscriber device 250 (i.e., the visited network address). For example, the home location privacy server 235 might transmit a network address request to the home database server 230 and receive the visited network address in response. That is, the home database server 230 may be configured such that it provides: (i) the visited network address in response to location requests received from the home location privacy server 235, and (ii) the privacy server network address in response to location requests received from anywhere but the home location privacy server 235 (e.g., a gateway location server 220).

Alternatively, when the services of the home location privacy server 235 are only required when the gateway location server 220 is not associated with the home network, the home database server 230 may be configured such that it provides: (i) the visited network address in response to location requests received from entities associated with the home network such as the home location privacy server 235 and any gateway location server 220 within the home network, and (ii) the privacy server network address in response to location requests received from any entity not associated with the home network (e.g., from a gateway location server 220 outside the home network).

The home location privacy server 235 uses the visited network address to transmit a location request to the visited network server 240 at (F). The visited network server 240 then communicates with the subscriber device 250 at (G) in order to determine the subscriber's current location (note that this process may also involve devices other than the visited network server 240 and the subscriber device 250).

When the subscriber's current location is determined, the visited network server 240 transmits the information to the home location privacy server 235 at (H).

At (I), the home location privacy server 235 forwards the location information to the gateway location server 220, which in turn relays the information to the client device 210 at (J). The client device 210 can then proceed to provide a location-dependent service to the subscriber (e.g., a roadside assistance service) or to another party (e.g., a friend or relative finder).

Communication System Overview

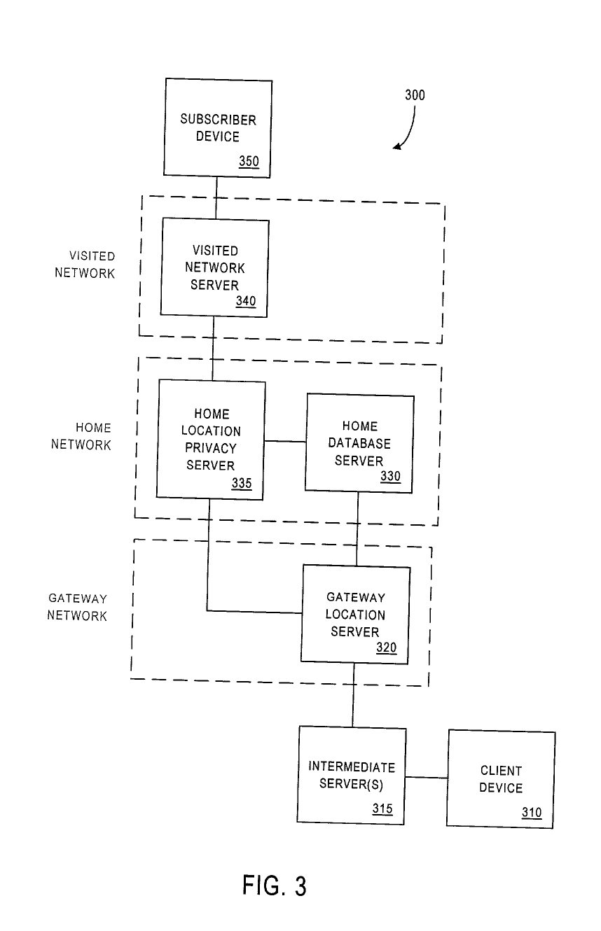

FIG. 3 is a block diagram overview of a communication system 300 according to some embodiments of the present invention. The communication system 300 may be associated with, for example, TIA, T1, 3GPP, and/or 3GPP2 wireless communication networks. Moreover, the communication system 300 may be associated with Global System for Mobile (GSM), PCS for 1900 MHz (PCS1900) and/or 3GPP Wideband Code Division Multiple Access (WCDMA) wireless technologies. The communication system 300 may also be associated with American National Standards Institute 41 (ANSI-41) wireless technologies, including Time Division Multiple Access (TDMA) or Code Division Multiple Access (CDMA).

As can be seen, a client device 310 communicates with a gateway location server 320 in a gateway network via one or more intermediate servers 315. By way of example, the intermediate servers 315 may comprise Location Services Clients (LSCs) and the gateway location server 320 may comprise a 3GPP or GSM Gateway Mobile Location Center (GMLC) or an ANSI-41 Mobile Position Center (MPC). Also note that the client device 310 may be associated with a person or a computer application that requests location information.

The gateway location server 320 also communicates with a home database server 330 in a home network, such as a Home Location Register (HLR) or Home Subscriber Server (HSS). For example, the gateway location server 320 may send a network address request to the home database server 330.

According to an embodiment of the present invention, the home database server 330 responds to the network address request by sending a privacy server network address to the gateway location server 320 (e.g., and not by sending an actual address associated with a network that is currently providing service to the subscriber device 350). The gateway location server 320 uses the privacy server network address to send a location request to the home location privacy server 335 in the home network. The home location privacy server 335 may contain, for example, a GMLC, a MPC or any other device capable of performing the functions described herein. Note that the home database server 330 and the home location privacy server 335 could be incorporated into a single physical device. Alternatively, or in addition, the home location privacy server 335 and a gateway location server 320 resident within the home network could be incorporated into a single physical device.

When the home location privacy server 335 receives the location request from the gateway location server 320, it may exchange information with the home database server 330 to determine an actual network address associated with a visited network that is currently providing service to the subscriber device 350.

Once the visited network address is determined, the home location privacy server 335 transmits a location request to a visited network server 340 in the visited network (e.g., the wireless communication network currently providing service to the subscriber device 350). The visited network server 340 may comprise, for example, a Mobile Switching Center (MSC) or a Serving GPRS Support Node (SGSN).

The visited network server 340 communicates with the subscriber device 350 in order to determine the current geographic location of the subscriber and returns the location information to the home location privacy server 335. The subscriber device 350 may comprise, for example, a GSM, a PCS1900, a TDMA, a CDMA, or a WCDMA Mobile Station (MS) or User Equipment (UE).

The home location privacy server 335 forwards the location information to the gateway location server 320 which, in turn, transmits the information to the client device 310 via the intermediate servers 315. The client device 310 may then provide a location-dependent service for either the subscriber (e.g., by transmitting a local weather report to the subscriber device 350) or some other party (e.g., by tracking the location of a truck or car as part of a fleet management system).

Home Database Server and Home Location Privacy Server Methods

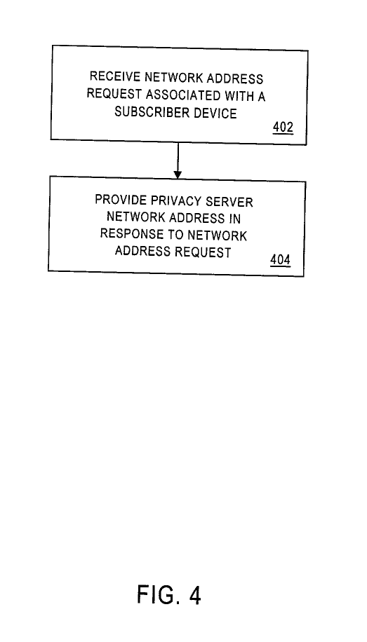

FIG. 4 is a flow chart of a home database server 330 method according to some embodiments of the present invention. The flow charts in FIG. 4 and the other figures described herein do not imply a fixed order to the steps, and embodiments of the present invention can be practiced in any order that is practicable.

At 402, a network address request is received at the home database server 330, the network address request being associated with a subscriber device 350. The network address request may be associated with a location request from a client device 310 asking for the current geographic location of the subscriber device 350 (e.g., associated with a wireless network subscriber). The network address request may be received from, for example, a gateway location server 320.

At 404, the home database server 330 provides a privacy server network address in response to the network address request. That is, the home database responds with an address associated with a home location privacy server 335 (and not an address associated with a visited network that is currently providing service to the subscriber device 350). For example, the home database server 330 may transmit the privacy server network address to the gateway location server 320.

According to some embodiments of the present invention, the home database server 330 also determines if the gateway location server 320 is associated with the subscriber's home network. That is, the home database server 330 may only respond with the privacy server network address when the gateway location server 320 is not associated with the subscriber's home network.

The home database server 330 may also receive a network address request from the home location privacy server 335. In this case, the home database server 330 may respond with the visited network address currently associated with the subscriber device 350 (e.g., by transmitting this information to the home location privacy server 335).

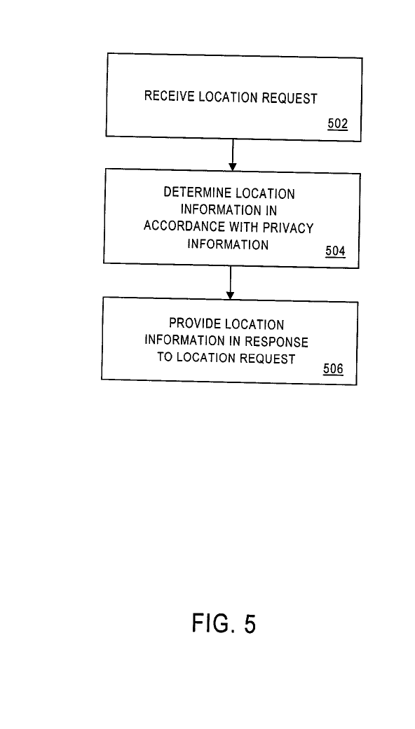

FIG. 5 is a flow chart of a home location privacy server 335 method according to some embodiments of the present invention. At 502, the home location privacy server 335 receives a location request, the location request being associated with a subscriber device 350. For example, the home location privacy server may receive the location request from a client device 310 via a gateway location server 320.

At 504, the home location privacy server 335 determines location information in accordance with privacy information associated with the subscriber device 350. For example, the home location privacy server 335 may retrieve and evaluate privacy information associated with the subscriber device 350 to determine if the location information will be disclosed to the client device 310. According to some embodiments, this determination is also based on the identity of the client device 310 associated with the location request (e.g., the privacy information might indicate that the location of the subscriber device 350 should not be disclosed to any client device 310 associated with advertising).

The home location privacy server 335 may determine the location information, for example, by transmitting a network address request to the home database server 330. In this case, the home location privacy server 335 may receive from the home database server 330 a visited network address associated with the subscriber device 350 and transmit a location request to a visited network server 340 using the visited network address. The home location privacy server 335 may then receive the subscriber's current location information from the visited network server 340.

At 506, the home location privacy server 335 provides the location information in response to the location request. For example, the home location privacy server 335 may transmit the location information to a client device 310 via a gateway location server 320.

### EXAMPLES

By way of example, consider Alice who one day rents an automobile and provides her wireless telephone number to the rental company with the understanding that her current location will only be disclosed to a roadside assistance service if she has reported a problem with the automobile.

Later that day, a client device 310 associated with the roadside assistance service transmits a location request to a gateway location server 320. The location request includes Alice's wireless telephone number, a client identifier associated with the roadside assistance service, and a purpose code associated with the specific location request (e.g., indicating that the location request is in response to a signal received from Alice's automobile).

The gateway location server determines Alice's home network and transmits a network address request (including her wireless telephone number) to her home database server 330 asking for the address of the network currently providing service to Alice's wireless telephone.

The home database server 330 may recognize that the gateway location server 320 is not associated with the home network and respond by sending a privacy server network address to the gateway location server 320 (now including Alice's wireless telephone number, a client identifier, and a purpose code). The gateway location server 320 uses the privacy server network address to send a location request to a home location privacy server 335 (e.g., as if the home location privacy server 335 was a visited network server 340).

The home location privacy server 335 retrieves Alice's privacy information, which indicates that her location should only be disclosed to a roadside assistance service if she has reported a problem with the automobile. The home location privacy server 335 verifies that this is the case and proceeds to determine the current location of Alice's wireless telephone (e.g., after exchanging information with the home database server 330 and a visited network server 340). The home location privacy server 335 can then provide the location information to the client device 310 via the gateway location server 320. In this example, the home location privacy server 335 could further verify that Alice has reported a problem the automobile before providing location information, by a direct communication with Alice (e.g., through an automated telephone call to Alice's wireless telephone). The need for such additional verification might be indicated by Alice's privacy information stored at the home location privacy server 335.

As another example, consider Bob who agrees to be located by a first company between 9:00 AM and 1:00 PM and by a second company between 1:00 PM to 5:00 PM during the work week (and by neither company during the weekend).

At 6:30 PM on a Monday, a client device 310 associated with the second company transmits a location request to a gateway location server 320. The location request includes Bob's wireless telephone number and a client identifier associated with the second company.

The gateway location server 320 determines Bob's home network and transmits a network address request (including his wireless telephone number) to his home database server 330 asking for the address of the network currently providing service to Bob's wireless telephone.

The home database server 330 may recognize that the gateway location server 320 is not associated with the home network and respond by sending a privacy server network address to the gateway location server 320. The gateway location server 320 uses the privacy server network address to send a location request (now including Bob's wireless telephone number and the client identifier) to a home location privacy server 335 (e.g., as if the home location privacy server 335 was a visited network server 340).

The home location privacy server 335 retrieves and evaluates Bob's privacy information. Because it is after 5:00 PM, the home location privacy server 335 transmits information to the gateway location server 320 indicating that Bob's location will not be disclosed to the client device 310 (e.g., an error message).

Home Database Server

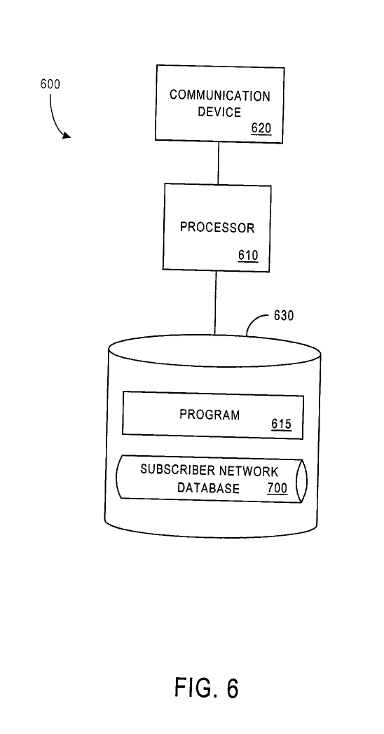

FIG. 6 illustrates a home database server 600 that is descriptive of the device shown, for example, in FIGS. 2 and 3 according to some embodiments of the present invention. The home database server 600 includes a processor 610, such as one or more INTEL® Pentium® processors. The processor 610 is coupled to a communication device 620 which may be adapted to communicate with, for example, a client device 350, a gateway location sever 320, a home location privacy server 335, a visited network server 340, and/or a subscriber device 350.

The processor 610 is also in communication with a storage device 630. The storage device 630 may comprise any appropriate information storage device, including combinations of magnetic storage devices (e.g., magnetic tape and hard disk drives), optical storage devices, and/or semiconductor memory devices such as Random Access Memory (RAM) devices and Read Only Memory (ROM) devices.

The storage device 630 stores a program 615 for controlling the processor 610. The processor 610 performs instructions of the program 615, and thereby operates in accordance with the present invention. For example, the processor 610 may receive a network address request, the network address request being associated with a subscriber device 350. The processor 610 may then provide a privacy server network address in response to the network address request.

As used herein, information may be “received” by or “transmitted” to a software application or module within the home database server from: (i) a gateway location server 320 or a home location privacy server 335, (ii) another software application or module within the home database server 600, or (iii) any other source.

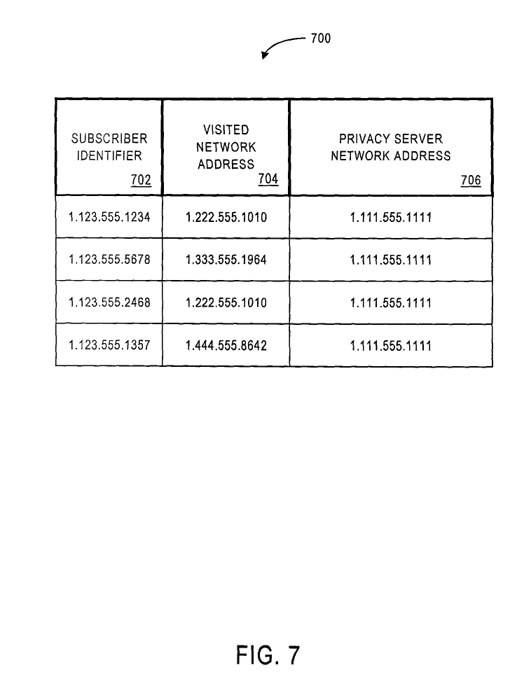

As shown in FIG. 6, the storage device 630 also stores a subscriber network database 700 (described with respect to FIG. 7). An example of a database that may be used in connection with the home database server 600 will now be described in detail. The illustrations and accompanying descriptions of databases presented herein are exemplary, and any number of other database arrangements could be employed besides those suggested by the figures.

Subscriber Network Database

Referring to FIG. 7, a table represents the subscriber network database 700 that may be stored at the home database server 600 according to an embodiment of the present invention. The table includes entries identifying wireless communication network subscribers or subscriber devices 350. The table also defines fields 702, 704, 706 for each of the entries. The fields specify: a subscriber identifier 702, a visited network or visited network server address 704, and a privacy server network address 706. The information in the subscriber network database 700 may be created and updated, for example, based on information received from a subscriber device 350, a visited network server 340, or a network administrator.

The subscriber identifier 702 may be, for example, an alphanumeric code associated with a wireless communication network subscriber or subscriber device 350 (e.g., a wireless telephone number). The visited network address 704 may be associated with a visited network that is currently providing service to the subscriber device 350 (e.g., the network address of the visited network server 340). The privacy server network address 706 may be associated with a home location privacy server 335 in the subscriber's home network. The subscriber identifier 702, the visited network address 704, and the privacy server network address 706 may each be, for example, numbers assigned in accordance with the ITU E.164 international numbering plan.

Other information might also be stored in the subscriber network database 700. For example, information about network address requests and location requests could be stored in the subscriber network database 700.

Home Location Privacy Server

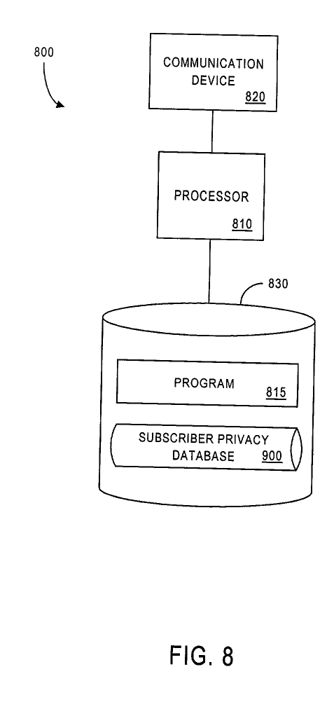

FIG. 8 illustrates a home location privacy server 800 that is descriptive of the device shown, for example, in FIGS. 2 and 3 according to some embodiments of the present invention. The home location privacy server 800 includes a processor 810, such as one or more INTEL® Pentium®) processors. The processor 810 is coupled to a communication device 820 which may be adapted to communicate with, for example, a client device 310, a gateway location sever 320, a home database server 330, a visited network server 340, and/or a subscriber device 350.

The processor 810 is also in communication with a storage device 830. The storage device 830 may comprise any appropriate information storage device, including combinations of magnetic storage devices, optical storage devices, and/or semiconductor memory devices such as RAM devices and ROM devices.

The storage device 830 stores a program 815 for controlling the processor 810. The processor 810 performs instructions of the program 815, and thereby operates in accordance with the present invention. For example, the processor 810 may receive a location request, the location request being associated with a subscriber device 350. The processor 810 may then determine location information in accordance with privacy information associated with the subscriber device 350 and provide the location information in response to the location request.

As used herein, information may be “received” by or “transmitted” to a software application or module within the home location privacy server 800 from: (i) a gateway location server 320, a home database server 330, or a visited network server 340, (ii) another software application or module within the home location privacy server 800, or (iii) any other source.

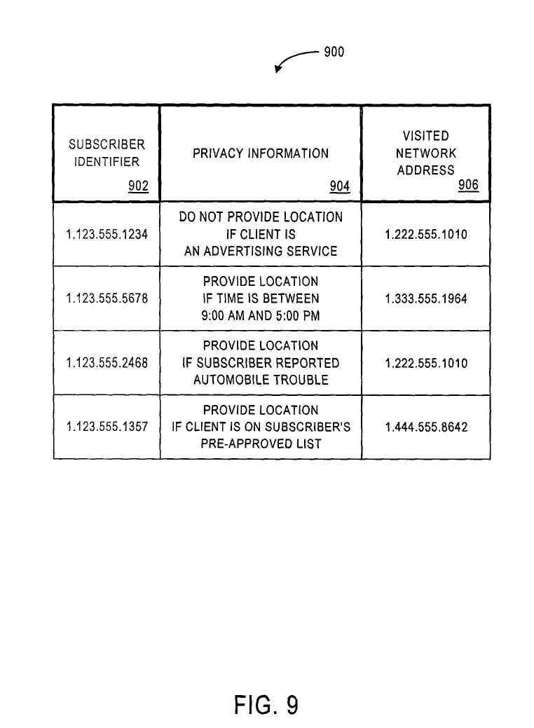

As shown in FIG. 8, the storage device 830 also stores a subscriber privacy database 900 (described with respect to FIG. 9). An example of a database that may be used in connection with the home location privacy server 800 will now be described in detail.

Subscriber Privacy Database

Referring to FIG. 9, a table represents the subscriber privacy database 900 that may be stored at the home location privacy server 800 according to an embodiment of the present invention. The table includes entries identifying wireless communication network subscribers or subscriber devices 350. The table also defines fields 902, 904, 906 for each of the entries. The fields specify: a subscriber identifier 902, privacy information 904, and a visited network address 906. The information in the subscriber privacy database 900 may be created and updated, for example, based on information received from a subscriber, a subscriber device 350, a home network server 330, a visited network server 340, or a network administrator.

The subscriber identifier 902 may be, for example, an alphanumeric code associated with a wireless communication network subscriber or subscriber device 350 (e.g., a wireless telephone number). The privacy information 904 may identify individual or categories of client devices 310 to which the location of a subscriber device 350 should or should not be disclosed together with rules and restrictions governing the circumstances under which disclosure should or should not occur. For example, as illustrated by the first entry in FIG. 9, the location of the subscriber device 350 should not be disclosed if the client device 310 is associated with an advertising service. The visited network address 906 may be associated with a visited network that is currently providing service to the subscriber device 350 (e.g., the network address of the visited network server 340). The visited network address 906 may be, for example, a number assigned in accordance with the ITU E.164 international numbering plan.

Other information might also be stored in the subscriber privacy database 900. For example, location information and the identities of certain clients associated with a subscriber (e.g., his or her friends and family members) could be stored in the subscriber privacy database 900.

Home Network Method

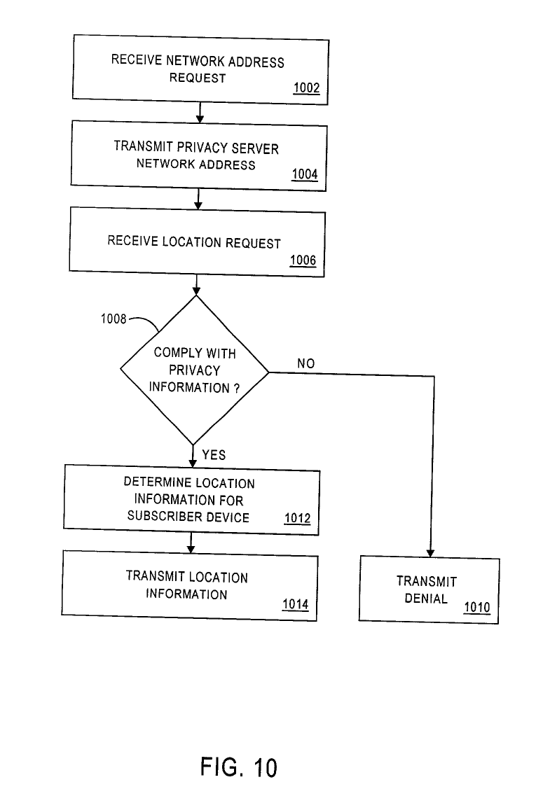

FIG. 10 is a flow chart of a method according to some embodiments of the present invention. The method may be performed, for example, by a home network (e.g., a home network including a home database server 330 and a home location privacy server 335).

At 1002, the home network receives a network address request. For example, a home database server 330 may receive from a gateway location server 320 a network address request associated with a client device 310 (e.g., associated with a client attempting to determine a subscriber's current location) and a subscriber device 350 (e.g., subscriber's wireless telephone number).

At 1004, the home network transmits a privacy server network address in response to the network address request (e.g., after determining that the sender of the network address request in 1002 is not associated with the home network). For example, the home database server 330 may retrieve the privacy server network address 706 from the subscriber network database 700 (e.g., based on the received wireless telephone number and the subscriber identifier 702) and transmit the privacy server network address to the gateway location server 320. The privacy server network address may be associated with, for example, a home location privacy server 335 in (or associated with) the home network.

At 1006, the home network receives a location request. For example, the home location privacy server 335 may receive from the gateway location server 320 a location request associated with the client device 310 and the subscriber device 350 (e.g., a location request including the subscriber's wireless telephone number).

The home network then determines if the received location request complies with privacy information at 1008. For example, the home location privacy server 335 may retrieve and evaluate privacy information 904 from the subscriber privacy database 900 (e.g., based on the received wireless telephone number and the subscriber identifier 902). The evaluation of the privacy information may be based on, for example, the identity and type of the client device 310, the time of day, the day of week, the date, and/or any other type of information.

If the location request does not comply with the privacy information at 1008, the home network transmits an indication of denial at 1010 (e.g., the home location privacy server 335 may transmit an error message to the gateway location server 320).

If the location request complies with the privacy information at 1008, the home network determines the current location of the subscriber device 350 at 1012. For example, the home location privacy server 335 can request the visited network address from the home database server 330. The home database server 330 may retrieve the visited network address 704 from the subscriber network database 700 and provide the information to the home location privacy server 335 (e.g., after recognizing that the home location privacy server 335 is associated with the home network). The home location privacy server 335 may then store the visited network address 906 in the subscriber privacy database 900 and use the information to send a location request to a visited network server 340 that is currently providing service to the subscriber device 350. The visited network server 340 can then determine and respond with the appropriate location information.

The home network then transmits the location information in response to the location request at 1014. For example, the home location privacy server 335 can transmit the location information to the gateway location server 320.

Thus, embodiments of the present invention may enable a home network to respond to a client's location request in accordance with a subscriber's privacy information. Moreover, this may be accomplished without any changes, or without substantial changes, to existing client devices 310, intermediate servers 315, gateway location servers 320, visited network servers 340, and subscriber devices 350.

Furthermore, the home network and the wireless network subscriber can be confident that an unauthorized client device 310 will not obtain location information for the subscriber device 350 by other means, because the home network is able to direct location request to the home location privacy server 335 through which location information must pass.

Additional Embodiments

The following illustrates various additional embodiments of the present invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

Although many embodiments have been described with respect to a home location privacy server 335 located in (or associated with) a home network, according to other embodiments the home location privacy server 335 is instead associated with a third-party service that responds to location requests for a number of different wireless network providers.

Moreover, some embodiments have been described with respect to the location of subscriber devices 350. Note, however, that the present invention may also be used to locate a subscriber. For example, the subscriber may need to provide a Personal Identification Number (PIN) or biometric information (e.g., a fingerprint scan) via the subscriber device 350 to verify that the subscriber is co-located with the subscriber device 350.

Although the evaluation of privacy information by a home location privacy server 335 has been described in detail, other devices can also evaluate privacy information in accordance with the present invention. For example, the client device 310, one or more intermediate servers 315, the gateway location server 320, the home database server 330, the visited network server 340, and/or the subscriber device 350 might evaluate privacy information in addition to the evaluation performed by the home location privacy server 335.

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

What is claimed is:

1. A method of facilitating subscriber location in accordance with privacy information, comprising:
receiving a network address request at a home database server, the network address request being associated with a subscriber device; and
providing a privacy server network address in response to the network address request.

2 The method of claim 1, wherein the network address request is associated with a location request from a client device.

3. The method of claim 2, wherein the location request is associated with a geographic location of the subscriber device.

4. The method of claim 1, wherein the subscriber device is associated with a wireless network.

5. The method of claim 1, wherein the network address request is received from a gateway location server.

6. The method of claim 5, wherein said providing comprises:
transmitting the privacy server network address to the gateway location server.

7. The method of claim 5, further comprising:
determining an association between the gateway location and a home network,
wherein said providing is only performed when the gateway location server is associated with the home network.

8. The method of claim 1, wherein the privacy server network address is associated with a home location privacy server.

9. The method of claim 8, further comprising:
receiving another network address request at the home database sever from the home location privacy server; and
transmitting a visited network address associated with the subscriber device.

10. The method of claim 9, wherein said transmitting comprises:
transmitting the visited network address to the home location privacy server.

11. The method of claim 1, wherein the home database server comprises at least one of: (i) a home location register, and (ii) a home subscriber server.

12. The method of claim 11, wherein the home database server is associated with at least one of: (i) GMS, (ii) ANSI-41, (iii) 3GPP, and (iv) 3GPP2.

13. The method of claim 1, wherein the home location privacy server is associated with at least one of: (i) a GSM gateway mobile location center, (ii) a 3GPP gateway mobile location center, (iii) an ANSI-41 mobile position center, and (iv) a 3GPP2 mobile position center.

14. A home database server, comprising:
a processor; and
a storage device in communication with said processor and storing instructions adapted to be executed by said processor to:
receive a network address request at a home database server, the network address request being associated with a subscriber device, and
provide a privacy server network address in response to the network address request.

15. The home database server of claim 14, wherein said storage device further stores a subscriber network database.

16. The home database server of claim 14, wherein said processor is further coupled to a communication device adapted to communicate with at least one of: (i) a client device, (ii) a gateway location server, (iii) a home location privacy server, (iv) a visited network server, (v) a subscriber device, and (vi) another home database server.

17. A medium storing instructions adapted to be executed by a processor to perform a method of facilitating subscriber location in accordance with privacy information, said method comprising:
receiving a network address request at a home database server, the network address request being associated with a subscriber device; and
providing a privacy server network address in response to the network address request.

18. A method of facilitating subscriber location in accordance with privacy information, comprising:
receiving a location request at a home location privacy server, the location request being associated with a subscriber device;
determining location information in accordance with privacy information associated with the subscriber device; and
providing the location information in response to the location request.

19. The method of claim 18, wherein the location request is received from a client device via a gateway location server.

20. The method of claim 18, wherein said providing comprises:
transmitting the location information to a client device via a gateway location server.

21. The method of claim 18, wherein said determining comprises:
retrieving privacy information associated with the subscriber device;
evaluating the privacy information; and
determining if the location information will be provided based on said evaluation.

22. The method of claim 21, wherein said evaluating is further based on at least one of: (i) a client device associated with the location request, (ii) a current time of day, (iii) a current day of week, (iv) a current date, (v) a characteristic of the location request, (vi) a location request purpose, and (vii) a location request type.

23. The method of claim 18, wherein said determining further comprises:
transmitting a network address request to a home database server;
receiving from the home database server a visited network address associated with the subscriber device;
transmitting a location request to a visited network server via the visited network address; and
receiving the location information from the visited network server.

24. A home location privacy server, comprising:
a processor; and
a storage device in communication with said processor and storing instructions adapted to be executed by said processor to:
receive a location request at a home location privacy server, the location request being associated with a subscriber device,
determine location information in accordance with privacy information associated with the subscriber device, and
provide the location information in response to the location request.

25. The home location privacy server of claim 24, wherein said storage device further stores a subscriber privacy database.

26. The home location privacy server of claim 24, wherein said processor is further coupled to a communication device adapted to communicate with at least one of: (i) a client device, (ii) a gateway location server, (iii) a home database server, (iv) a visited network server, (v) a subscriber device, and (vi) another home location privacy server.

27. A medium storing instructions adapted to be executed by a processor to perform a method of facilitating subscriber location in accordance with privacy information, said method comprising:
receiving a location request at a home location privacy server, the location request being associated with a subscriber device;
determining location information in accordance with privacy information associated with the subscriber device; and
providing the location information in response to the location request.

28. A method of facilitating subscriber location in accordance with privacy information, comprising:
receiving a network address request at a home database server, the network address request being associated with a subscriber device;
transmitting a privacy server network address in response to the network address request;
receiving a location request at a home location privacy server, the location request being associated with a client device and the subscriber device;
determining location information in accordance with privacy information associated with at least one of the client device and the subscriber device; and
transmitting the location information in response to the location request.
